(19) United States
(12) Patent Application Publication
(10) Pub. No.: US 2006/0262542 A1
(43) Pub. Date: Nov. 23, 2006

(54) Modular landscape light fixture

(75) Inventors: Ian R. Ibbitson, Seal Beach, CA (US); Arthur L. Smith, Huntington Beach, CA (US)

Correspondence Address: FITZPATRICK CELLA HARPER & SCINTO, 30 ROCKEFELLER PLAZA, NEW YORK, NY, 10112, US

(73) Assignee: JJI LIGHTING GROUP, INC., Greenwich, CT (US)

(21) Appl. No.: 11/131,550

(22) Filed: May 18, 2005

(51) Int. Cl. F21S 8/00; F21V 19/02; F21V 17/00; E01F 9/00

(52) U.S. Cl. 362/368; 362/375; 362/372; 362/153.1

(57) ABSTRACT

A multi-use landscape light fixture is provided. The landscape light fixture includes a main housing, a lens assembly, a light source mount assembly and a base. The main housing has an upper flanged opening and a lower flanged opening. The upper opening is used for mounting a lens or the like using the lens ring. The lower opening has a flange used for mounting the base. The base has an upper portion that is inserted into the bottom opening of the main housing and a lower flanged bulkhead that mates with the flange of the main housing. Once mated, the flanged bulkhead forms a watertight seal with the lower flange of the main housing. The base includes power and signal connectors and separate compartments for ballast circuitry and junctions. The landscape light fixture may be mounted above, below or at any level in between grade.

### BACKGROUND AND SUMMARY

1. Field of the Invention

The present invention relates to a an outdoor light fixture that is exposed to the elements, such as rain, snow, etc. More specifically, the present invention is a modular landscape light fixture that may be installed above, below or at any level in between grade. Once installed, the light projects upwards, for example, onto trees, buildings, and the like, either from the ground or from a position elevated above the ground. Such lighting, called up-lighting, is commonly used to provide accent lighting and to beautify an area without noticeably invading the area's space.

2. Description of the Related Art

Conventional landscape light fixtures used for up-lighting are disposed in the ground. These in-ground landscape light fixtures have a housing which contains a light source, electrical components such as a ballast, and power terminals. Power enters these conventional fixtures by means of a power cable passing through a hole or a junction box.

Tubular fittings, water-tight couplings, gaskets and the like are used in an attempt to prevent water from entering the fixtures from the surrounding ground through the hole or junction box. In addition, a potting compound such as epoxy is sometimes used to surround electrical components and contacts within the fixture in order to protect them from water. However, forming a truly water-tight seal with any of these conventional means can be difficult because of water's ability to siphon, motivated by changes in the internal pressure of a fixture caused by thermal cycling, or wick, possibly by means of capillary action, through the smallest opening or along boundaries between materials.

Another problem with conventional up-lighting is that the light can become obscured by low-growing shrubs and other plants, leaves, grass clippings and other obstructions close to the ground. When the light is obscured, the light neither provides accent lighting nor beautifies the area.

Traditionally, landscape light fixtures were cast or molded tapering from a larger top to a smaller bottom. Until composite technology came into its own, either aluminum or bronze was used. Bronze is very expensive and aluminum proved troublesome as more acid and alkaline were added to the soil. Today, most reputable manufactures provide landscape light fixtures manufactured using composite technology. The main disadvantage of composite material is that it is an insulator and it is harder to dissipate heat.

Another approach is the well light concept where the lighting components were inserted in and/or hung from an external tube. These type of product in their basic form have been abandoned because of the issues of sealing all the components from the water that invaded the tube. However, one of the advantages of a tube design which is still used by some manufactures is the ability to allow heat to escape or vent. The advantage is also a disadvantage because water and dirt can penetrate the fixture. To avoid such problems, all of the components are water-proofed and connected via water tight connectors. In addition, the tube is typically much more complex today than a simple tube.

Some European manufacturers still use die-cast aluminum and stainless steel product usually inserted in a tube. The main reason for this is that they typically use the product in a pedestrian environment and have much easier and simpler methods of connecting power without using conduits.

No matter what the design or how complex the biggest issue still remaining to be solved is stopping water entry in the first place. The main issues are either at the point of installation (bad contractor) or maintenance (poor maintenance). Not following the correct procedures such as cleaning gasketed surfaces or tightening the screws in a rotational manner usually creates the problem.

In general manufactures have tried to minimize the effects of water penetration by sealing the ballast/transformer either by potting it or enclosing it in a sealed chamber. Also some manufacturers have separately sealed the lamp/reflector assembly.

One solution to the water entry problem is disclosed in U.S. Pat. No. 5,743,622 issued to Ibbitson (Ibbitson). Ibbitson discloses an in-ground fixture installed above ground by means of a tube. Once above ground the water issue greatly diminishes because the fixture is in contact with less moisture. Furthermore, the fixture includes anti-wicking chambers that minimizes water entry even further. In addition, as the fixture is mounted within the tube, the fixture may be mounted in a variety of different ways such as above-grade.

Another approach to landscape light fixture design is disclosed in U.S. Pat. No. 5,908,236 issued to Lueken et al. (Lueken). Lueken discloses a landscape light fixture for below-grade use. However, the landscape light fixture of Lueken suffers from several deficiencies. The bottom is permanently sealed to the bottom of the lamp housing. This prevents the light fixture from being rebuilt if the bottom should be damaged such as by corrosion or mechanical damage caused by an installation error or the like. In addition, the lamp housing and the bottom are generally frustoconical in shape and joined at their bases. This means the overall shape of the light fixture is not conducive to installation partially below grade or above grade. If mounted such that the lamp housing is above grade with the bottom below grade, the tapered shape of the ballast housing causes the light fixture to frost heave out of the ground during the winter months. If mounted entirely above ground, the bottom presents an unattractive aspect that is not esthetically harmonious within a garden or as a landscape element.

Therefore, a need exists for a landscape light fixture that is inexpensive to manufacture, easily serviced in the field and is capable of being mounted above grade, partially below grade or entirely below grade. Landscape light fixtures manufactured in accordance with various aspects of the present invention meet such a need.

### SUMMARY OF THE INVENTION

In accordance with an exemplary embodiment of the present invention, a landscape light fixture includes a main housing, a lens assembly and a base housing a ballast and a junction box. The main housing is elongated and has an upper flanged opening and a lower flanged opening. The upper flanged opening has a flange protruding inwardly into the upper opening. The inwardly protruding flange is used for mounting a lens or the like using the lens assembly. The lower flanged opening has an outwardly protruding flange used for mounting the base. Once the lens assembly and base are sealably but removably attached to the main housing at their respective flanges, the light fixture forms a sealed housing for a light source. The light fixture may be mounted above grade, below grade, or at any elevation in between.

In another aspect of the invention, the main housing is substantially cylindrical with a 0.5 degree draft tapering outwardly from the top opening to the bottom opening.

In another aspect of the invention, the flange of the upper flanged opening of the main housing has a plurality of internally threaded openings for mating with fasteners that secure the lens assembly. The interior of the openings include channels communicating with an exterior of the main housing that allow dirt or other debris to pass through the threaded openings when the fasteners are threaded into the openings.

In another aspect of the invention, the base has an upper portion that is inserted into the bottom opening of the main housing and a lower flanged bulkhead that mates with the outwardly protruding flange of the main housing. Once mated, the flanged bulkhead forms a watertight seal with the outwardly protruding flange of the main housing.

In another aspect of the invention, the upper portion of the base includes a ballast compartment having an upper opening facing into the interior of the main housing. The upper opening is provided with a cover having a hinged handle on the cover's upper surface. The handle may be used to retrieve the cover to open the ballast compartment while still stowing away in a compact fashion when not in use.

In another aspect of the invention, the ballast chamber cover is composed of a heat conducting material and a ballast is coupled to an interior side of the cover. In this way, the cover serves as a heat sink for the ballast.

In another aspect of the invention, the base has external bosses for mounting electrical conduit couplers to the junction box.

In another aspect of the invention, the base includes connectors for signal lines used to transmit control signals to the light fixture.

In another aspect of the invention, the base includes electrical conductors extending from between compartments and between the compartments and the interior of the main housing. The conductors pass through antiwicking chambers molded into the base. The antiwicking chambers hold antiwicking connectors that are potted into place.

In another aspect of the invention, the lens assembly includes two lenses in a spaced apart relationship whereby heat transfer between the light fixture and an outermost lens surface is reduced.

In another aspect of the invention, the light fixture includes a light source mount assembly including a ball and socket joint between a base and a light source subassembly. The ball is fixedly but releasably held in the socket. To reposition the light source, the ball is released from the socket, thereby allowing the ball to rotate within the socket, and the light source is set in position. Once the light source has been repositioned, the ball is again fixedly held in the socket, thus fixing the light source in position. In one embodiment of the light source mount assembly, the ball is fixedly held in the socket by a spring mechanism. In another embodiment, the ball is fixedly held in the socket by a mechanical linkage. In another embodiment of the light source mount assembly, the ball is fixedly held in the socket by a set screw.

This summary has been provided so that the nature of the invention may be understood quickly. A more complete understanding of the invention can be obtained by reference to the following detailed description, appended claims, and accompanying drawings.

### BRIEF DESCRIPTION OF THE DRAWINGS

FIG. 1a is a side-view of a landscape light fixture installed below-grade in accordance with an exemplary embodiment of the present invention.

FIG. 1b is a side-view of a landscape light fixture installed mid-grade in accordance with an exemplary embodiment of the present invention.

FIG. 1c is a side-view of a landscape light fixture installed above-grade in accordance with an exemplary embodiment of the present invention.

FIG. 2a is a cross-sectional view of a landscape light fixture in accordance with an exemplary embodiment of the present invention.

FIG. 2b is a cross-sectional view of a landscape light fixture including dual lenses in accordance with an exemplary embodiment of the present invention.

FIG. 3a is a bottom perspective view of a base for a landscape light fixture in accordance with an exemplary embodiment of the present invention.

FIG. 3b is a top perspective view of a base for a landscape light fixture in accordance with an exemplary embodiment of the present invention.

FIG. 4a is a top view of a ballast cover for a ballast compartment in a base for a landscape light fixture in accordance with an exemplary embodiment of the present invention.

FIG. 4b is a cross-sectional view of a ballast cover for a ballast compartment in a base for a landscape light fixture in accordance with an exemplary embodiment of the present invention.

FIG. 4c is a bottom view of a ballast cover for a ballast compartment in a base for a landscape light fixture in accordance with an exemplary embodiment of the present invention.

FIG. 4d is a perspective view of a ballast cover for a ballast compartment in a base for a landscape light fixture in accordance with an exemplary embodiment of the present invention.

FIG. 5a is a top view of a main housing for a landscape light fixture in accordance with an exemplary embodiment of the present invention.

FIG. 5b is a partial cross-sectional view of a main housing for a landscape light fixture in accordance with an exemplary embodiment of the present invention.

FIG. 5c is bottom view of a main housing for a landscape light fixture in accordance with an exemplary embodiment of the present invention.

FIG. 5d is a perspective view of a main housing for a landscape light fixture in accordance with an exemplary embodiment of the present invention.

FIG. 6 is a cross-sectional view of a landscape light fixture with an adjustable light source mount assembly in accordance with an exemplary embodiment of the present invention.

FIG. 7a is a cross-sectional view of an adjustable light source mount assembly in accordance with an exemplary embodiment of the present invention.

FIG. 7b is a top view of an adjustable light source mount assembly in accordance with an exemplary embodiment of the present invention.

FIG. 7c is a perspective view of an adjustable light source mount assembly in accordance with an exemplary embodiment of the present invention.

FIG. 8a is a cross-sectional view of an adjustable light source mount assembly including a mechanical linkage in accordance with an exemplary embodiment of the present invention.

FIG. 8b is a cross-sectional view of an adjustable light source mount assembly including a set screw in accordance with an exemplary embodiment of the present invention.

FIG. 9 is a block diagram of a control circuit for a landscape light fixture in accordance with an exemplary embodiment of the present invention.

### DETAILED DESCRIPTION

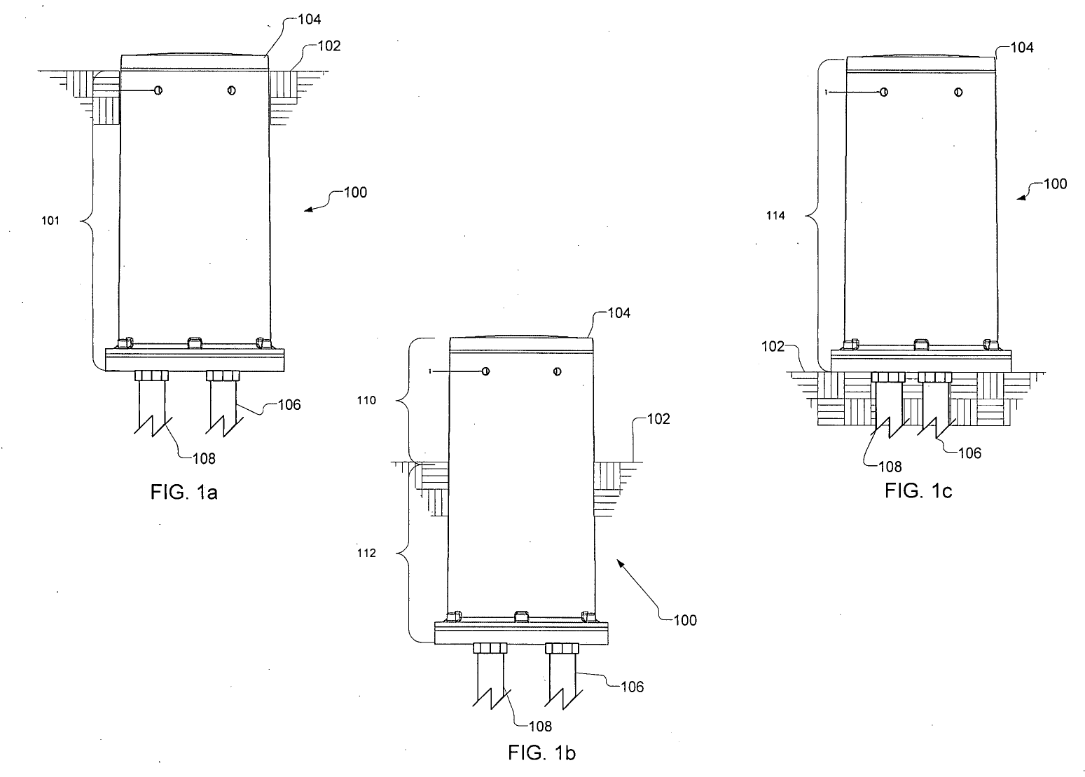

FIG. 1a is a side-view of a landscape light fixture 100 installed below-grade in accordance with an exemplary embodiment of the present invention. In this drawing, the landscape light fixture is shown installed such that a major portion 101 of the landscape light fixture is located below grade 102 in a landscape setting. In this configuration, only a small portion of the landscape light fixture is above-grade, such as a lens ring 104. This configuration is useful for mounting the landscape light fixture in the earth or into a paved surface such as walkway. When installed below-grade, the landscape light fixture presents a minimal above-grade profile. Electrical power connections to the landscape light fixture may be made through conduit 106 coupled to the landscape light fixture. Additional electrical power connections or control signal connections may be made through an additional conduit 108 coupled to the landscape light fixture.

FIG. 1b is a side-view of a landscape light fixture 100 installed mid-grade in accordance with an exemplary embodiment of the present invention. In this configuration, the landscape light fixture is mounted so that substantially more of an upper portion 110 of the landscape light fixture extends above grade level 102 instead of just lens ring 104 as in FIG. 1a. However, a significant portion 112 of the landscape light fixture is still below grade level. This configuration is useful when the landscape light fixture is installed in a landscape setting where there are small plants or ground cover that may tend to obscure an aperture (not shown) in the lens ring. As before, power and control signal connections may be made through conduits 106 and 108.

FIG. 1c is a side-view of landscape light fixture 100 installed above-grade in accordance with an exemplary embodiment of the present invention. In this configuration, the landscape light fixture is installed almost entirely above a grade level 102 such that substantially all 114 of the landscape light fixture extends above grade. This configuration is useful for mounting the landscape light fixture in landscape settings where brush or other landscaping elements may be tall enough to obscure an aperture (not shown) in lens ring 104. As in FIG. 1a and FIG. 1b, electrical power and control signal connections may be made through conduits 106 and 108.

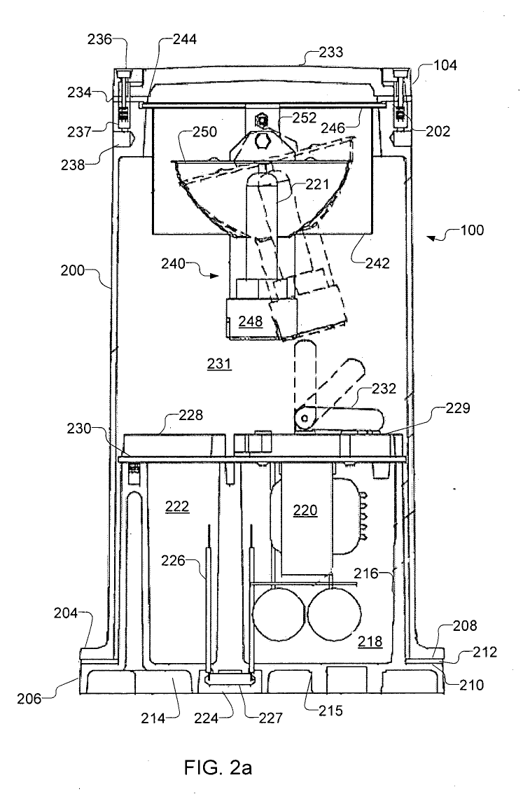

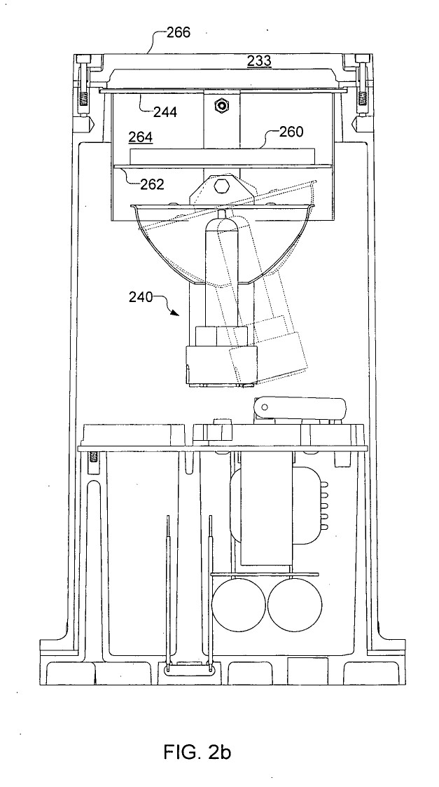

FIG. 2a is a cross-sectional view of landscape light fixture 100 in accordance with an exemplary embodiment of the present invention. The landscape light fixture includes a main housing 200 that is substantially cylindrical having an upper and lower opening. The main housing is coupled to lens ring 104 at an upper flange 202 extending into the upper opening of the main housing. The main housing further includes a lower flange 204 surrounding the lower opening. The lower flange serves as a connector for a base 206 that is removably and sealably coupled to the main housing at the lower opening. The base has a mating flange for mating to the lower flange on the main housing. The main housing flange includes a sealing surface 208 that mates with a sealing surface 210 on the base flange with sealing material such as a gasket 212 therebetween.

In an exemplary embodiment of a landscape light fixture in accordance with the invention, the main housing lower flange extends outwardly from an exterior surface of the landscape light fixture. In a similar fashion, the flange on the base also extends outwardly from the exterior surface of the landscape light fixture. This enables the flange to serve an additional purpose as an anti-heaving feature allowing the landscape light fixture to resist frost heave by anchoring the fixture in the earth when the fixture is installed below-grade or at mid-grade.

In another exemplary embodiment of a landscape light fixture in accordance with the invention, the flanged base also functions as a stabilizer providing a mounting base wider than the diameter of the main housing when the fixture is installed above-grade.

The base includes one or more bosses 214 for receiving connectors, such as conduit or cabling connectors, used to make connections to power or signal lines as previously described.

The base further includes an upper portion 216 that extends from the flanged base and into the main housing. The upper portion includes a ballast compartment 218 in communication with connectors coupling power and control signals to the landscape light fixture. The ballast compartment houses a light source ballast 220 and any other control circuitry used to control a light source 221 mounted within an interior portion 231 of the main housing. The ballast housing is coupled to a junction box compartment 222 via an antiwicking chamber 224. One or more electrical conductors 226 pass from the ballast compartment, through the antiwicking chamber and into the junction box compartment. The electrical conductors may be coupled to an antiwicking conductor assembly 227 housed in the antiwicking chamber. The antiwicking chamber is filled with a potting material that seals the chamber from the external environment, seals around the electrical conductors and forms a seal between the antiwicking chamber and the ballast and junction box compartments.

The base further includes a junction box cover 228 used to cover the junction box compartment and a ballast cover 229 used to cover the ballast compartment. The covers are sealably and removably attached to the base by a compartment gasket 230. The covers serve to separate the ballast and junction box compartments from the interior portion of the main housing.

The ballast cover further functions as a mount for the ballast and associated circuitry. The cover includes a handle 232 used to extract the ballast cover and ballast from the landscape light fixture through the upper opening. In one ballast cover in accordance with an exemplary embodiment of the present invention, the handle is coupled to the ballast cover by one or more hinges. This allows the handle to be stowed when not in use this maximizing the amount of space available in the interior portion of the main housing for mounting a light source.

In one ballast cover in accordance with an exemplary embodiment of the present invention, the ballast cover is composed of a thermally conductive material and the ballast is thermally coupled to the ballast cover. This allows the ballast cover to act as a heat sink for the ballast. This effect is enhanced by external ribbing on the cover.

The upper opening of the main housing is covered by an upper lens 233 held in place by upper lens ring 104. The lens is sealably coupled to the lens ring with a sealing material, such as a portion of bifurcated lens gasket 234 or the like, therebetween. In addition, the lens ring is sealably coupled to the main housing at sealing surface 202 with a portion of the lens gasket therebetween. The lens ring is held in place by one or more captive threaded fasteners 236 that are threaded into one or more interiorly threaded openings 237 in the main housing. At the base of each opening are debris removal outlets 238 that allow debris in the threaded openings to escape when the captive threaded fasteners are introduced into the openings.

Housed within the interior portion of the main housing is a gimbal ring 244 having an outer peripheral portion captured in a groove 246 in the inwardly extending sealing surface of the upper flange. Mounted to the gimbal ring are a light source mount assembly 240 held in the upper opening of the main housing and a UV shield 242.

The light source mount assembly holds the light source 221 and includes a reflector 250 surrounding the light source. The light source mount assembly is coupled to the gimbal ring by a hinge 252 whereby a longitudinal axis of the light source mount assembly may be fixed at an angle in respect to a longitudinal axis of the main housing. In conjunction with rotating the gimbal ring in respect to the main housing, this allows the light source to be aimed after the landscape light fixture is installed.

FIG. 2b is a cross-sectional view of a landscape light fixture including dual lenses in accordance with an exemplary embodiment of the present invention. In this light fixture, a second lens 260 is mounted to gimbal ring 244 inside the main housing. The second lens is held in a spaced apart relationship to lens 233 between lens 233 and light source mount assembly 240. The second lens is held within UV shield 242 by a lens ring 262. The lens ring partially seals the second lens to the UV shield, thus impeding convective heat transfer into an upper portion 264 of the interior of the main housing. In addition, the second lens reduces radiative heat transfer as well. This reduces the amount of heat transferred by the ballast and light source to an outer surface 266 of the upper lens, thus lowering the temperature of the outer surface of the upper lens.

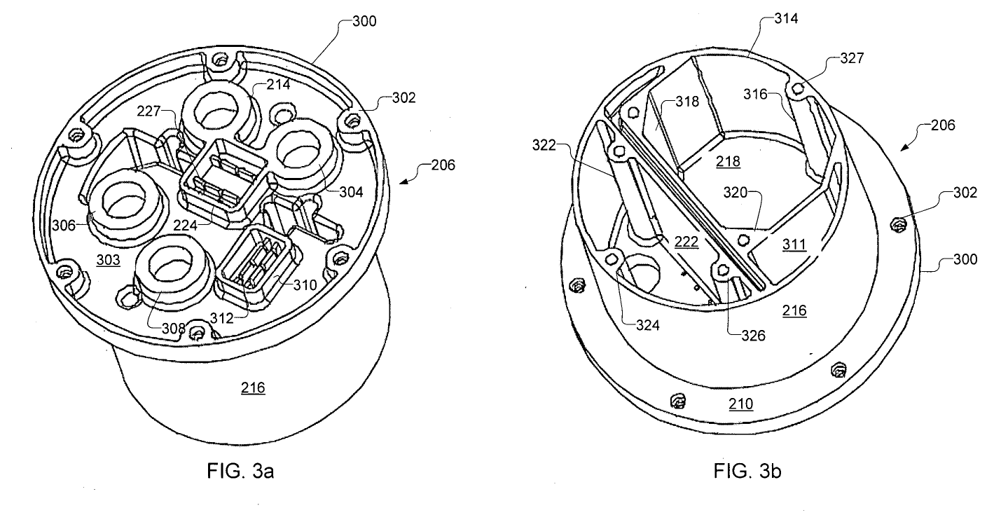

FIGS. 3a and FIG. 3b depict a bottom perspective view and a top perspective view, respectively, of base 206. The base has a mating flange 300 for mating to lower flange 204 (of FIG. 2a) on the main housing. The main housing lower flange includes sealing surface 208 (of FIG. 2a) that mates with sealing surface 210 on the base flange with a sealing material such as gasket 212 (of FIG. 2a) therebetween. The flange has one or more interiorly threaded openings 302 spaced apart about the base flange's periphery. The threaded openings are for receiving threaded fasteners (not shown) attaching the base flange to main housing flange 204 (of FIG. 2a).

A bottom surface 303 of the base includes one or more bosses, such as bosses 214 and 304, for receiving power connectors, such as conduit or cabling connectors, used to make electrical power connections to the landscape light fixture. The bosses open into a junction box compartment 222 in the upper portion of the base.

The bottom surface of the base further includes antiwicking chamber 224 including antiwicking device 227. The antiwicking chamber allows one or more conductors 226 (of FIG. 2a) to pass from the junction box compartment, through the antiwicking chamber and into ballast box compartment 218. The electrical conductors may be coupled to antiwicking conductor assembly 227 housed in the antiwicking chamber. The antiwicking chamber is filled with a potting material that seals the chamber from the external environment, seals around the electrical conductors and forms a seal between the antiwicking chamber and the ballast and junction box compartments.

The bottom surface of the base further includes one or more bosses, such as bosses 306 and 308 for receiving connectors, such as conduit or cabling connectors, used to make control signal connections to the landscape light fixture. The bosses open into ballast compartment 218 in upper portion 216 of the base that extends into main housing 200 (of FIG. 2a). The bottom surface of the base further includes a second antiwicking chamber 310 housing a second antiwicking assembly 312. The second antiwicking chamber allows one or more conductors to pass between the ballast compartment and a channel 311 leading up to interior portion 231 of main housing 200 (both of FIG. 2a).

A top surface 314 of the base serves as a sealing surface between the ballast compartment and the junction box compartment and their respective covers 228 and 229 (both of FIG. 2a). The compartments include bosses, such as bosses 316, 318 320, 322, 324 and 326 extending from the top surface and into the compartments. The bosses include one or more interiorly threaded openings, such as opening 327, for receiving threaded fasteners that hold the covers on the top surface of the base.

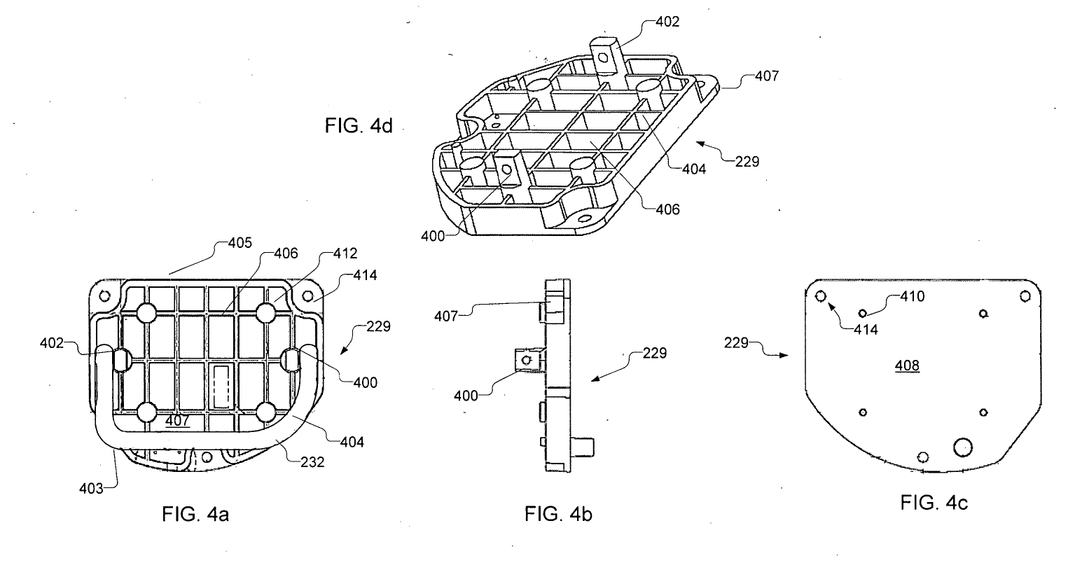

FIGS. 4a, 4b, 4c and 4d depict, respectively, a top view, a cross-sectional side view, a bottom view and a perspective view of ballast cover 229 in accordance with an exemplary embodiment of the present invention. The ballast cover includes a handle 232 (shown only in FIG. 4a) coupled to the ballast cover by hinges 400 and 402. The handle is contoured to fit within main housing 200 (of FIG. 2a) and within the overall envelope of the ballast cover as viewed from above. Accordingly, the handle has a first inwardly curving portion 403 and a second inwardly curving portion 404 with each inwardly curving section having a different radius of curvature.

The ballast cover also includes one or more intersecting ribs, such as ribs 405 and 406, extending upwardly from an upper surface 407. The ribs serve to both strengthen the ballast cover and to provide a finned heat sink for any electrical circuitry mounted on a bottom surface 408 of the ballast cover. To facilitate mounting of the electrical circuitry, the ballast cover includes one or more interiorly threaded openings 410 extending from the bottom surface into one or more corresponding bosses 412 on the upper surface of the ballast cover. The ballast cover also has one or more through-drilled openings 414 extending from the upper surface to the bottom surface to facilitate attaching the ballast cover to base 206 (of FIG. 2a).

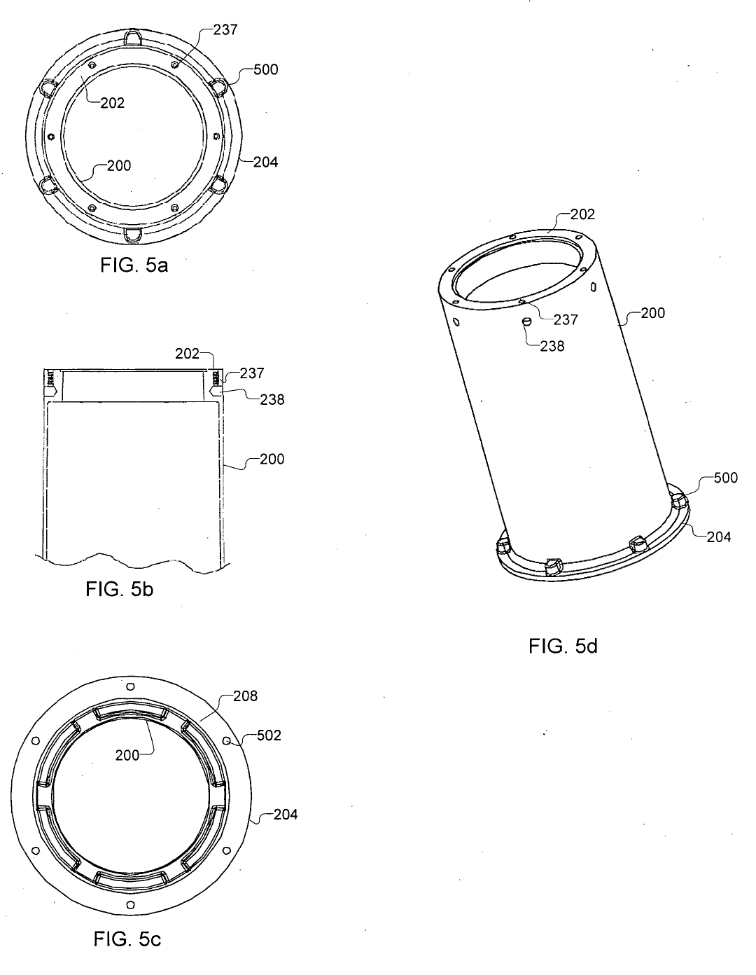

FIGS. 5a, 5b, 5c and 5d depict, respectively, a top view, a partial cross-sectional view, a bottom view and a perspective view of main housing 200 for a landscape light fixture in accordance with an exemplary embodiment of the present invention. The main housing is substantially cylindrical having an upper and lower opening. The main housing is coupled to lens ring 104 (of FIG. 1) at upper flange 202 extending into the upper opening of the main housing. The main housing further includes lower flange 204 serving as a connector for base 206 (of FIG. 2a) that is coupled to the main housing at the lower opening. The lower flange includes sealing surface 208 that mates with sealing surface 210 (of FIG. 2a) on the base flange with sealing material such as gasket 212 therebetween.

The main housing may be cylindrical in shape or be tapered. In one main housing in accordance with an exemplary embodiment of the present invention, the taper is a 0.5 degree draft that facilitates manufacturing the main housing in a molding process.

A lens ring 104 (of FIG. 1a) is held in place by captive threaded fasteners that are threaded into one or more spaced apart interiorly threaded openings 237 in the periphery of the upper opening of the main housing. At the base of each opening is a debris removal outlet 238 that allows debris in the threaded opening to escape when a threaded fastener is introduced into the opening.

An upper surface of the main housing flange includes one or more bosses 500 spaced apart around an upper surface of a periphery of the flange. The bosses correspond to one or more interiorly threaded openings 502 extending from a lower surface of the flange into the bosses. These threaded openings receive threaded fasteners that removably attach base 206 (of FIG. 2) to the main housing.

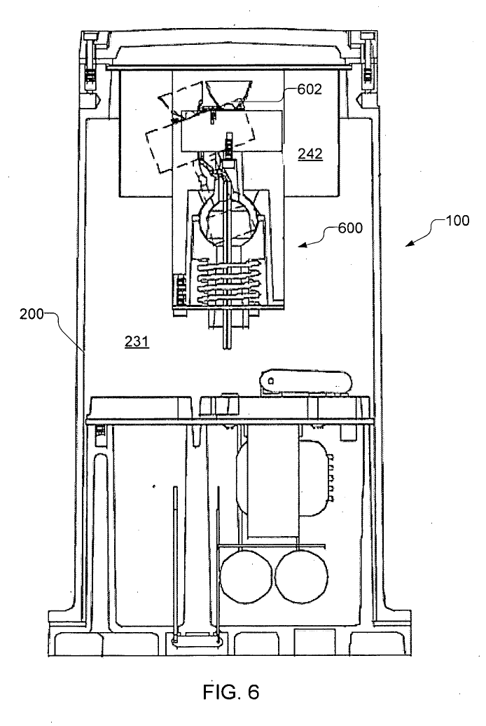

FIG. 6 is a cross-sectional view of landscape light fixture 100 with an adjustable light source mount assembly 600 in accordance with an exemplary embodiment of the present invention. The adjustable light source mount assembly is fixedly attached to UV shield 242 and/or to gimbal ring 244 within the interior portion 231 of main housing 200 of the landscape light fixture. The adjustable light source mount assembly allows a light source 602 to be aimed through adjustment along two axis without having to adjust the gimbal ring in respect to the main housing as in light source mount assembly 240 of FIG. 2a.

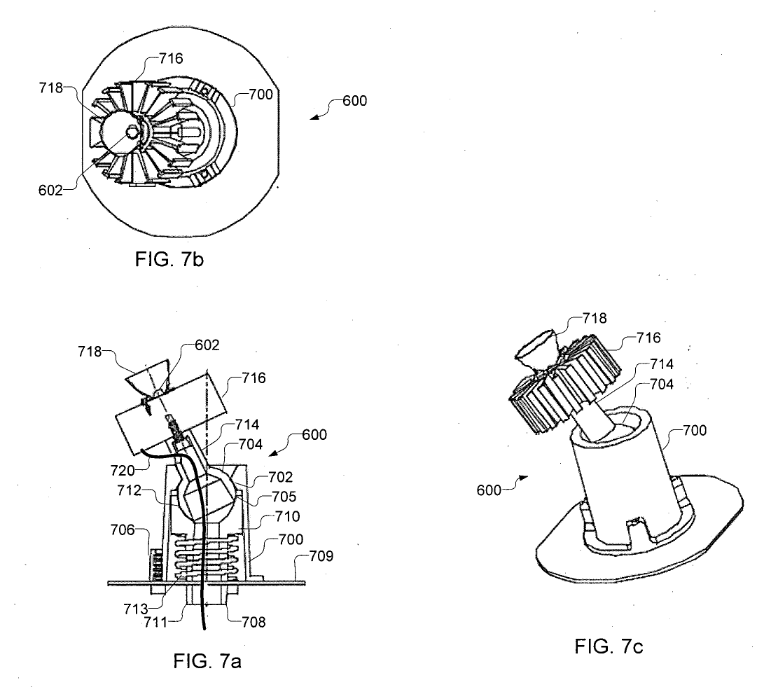

FIGS. 7a, 7b and 7c depict, respectively, a cross-sectional view, a top view and a perspective view of adjustable light source mount assembly 600 in accordance with an exemplary embodiment of the present invention. The adjustable light source mount assembly includes a light source mount subassembly 700 having an internal bore culminating at one end of the light source mount subassembly in a through-bored socket 702 for receiving a ball and stem assembly 704 having a ball 705 and a stem 714. The stem of the ball and stem assembly extends through the bore of the socket. The light source mount subassembly further includes one or more external bosses 706 having interiorly threaded openings extending therein for receiving threaded fasteners.

The light source mount subassembly further includes a socket plunger 708 having an interior bore. The plunger extends upwardly into the internal socket thereby capturing the ball of the ball and stem assembly within the internal socket of the light source mount subassembly. The socket plunger has a head 710 which is larger in diameter than a tail portion 711 that extends through an opening in a mounting platform 709. The head portion includes an exterior socket 712 that mates with the ball of the ball and stem assembly. A compression spring extends over the tail of the plunger and is captured between the head of the plunger and the mounting platform.

The ball stem extends upwards away from the light source mount subassembly and serves as mount for a light source assembly including a light source 602, a finned heat sink 716 and a reflector 718. The ball and stem assembly has an interior bore with a side opening at an upper end through which wiring 720 for the light source may pass.

Once the adjustable light source mount assembly is assembled, the compression spring urges the socket plunger upwards into the bore of the light source mount subassembly. The external socket portion of the head of the plunger, in turn, forces the ball of the ball and stem assembly against the internal socket of the light source mount subassembly, thereby holding the ball trapped between the internal socket and the socket on the head of the socket plunger. To adjust the aim of the light source assembly, the ball and stem assembly may be pushed downward against the socket in the head of the socket plunger which compresses the compression spring further, thus freeing the ball from the internal socket. Once the ball is freed, the ball and stem assembly may be adjusted to aim the light source assembly as needed. Releasing the ball allows the compression spring to urge the ball back up into the internal socket of the light source mount subassembly, trapping the ball once more, thereby holding the aim of the light source assembly in place.

The adjustable light source mount assembly may be used with a variety of light source assemblies to accommodate light sources that operate on different principles. For example, the light source assembly may include a heat sink and small reflector as shown, thereby permitting use of a Light Emitting Diode (LED) style light source. Alternatively, the light source assembly may include a large reflector for other types of light sources.

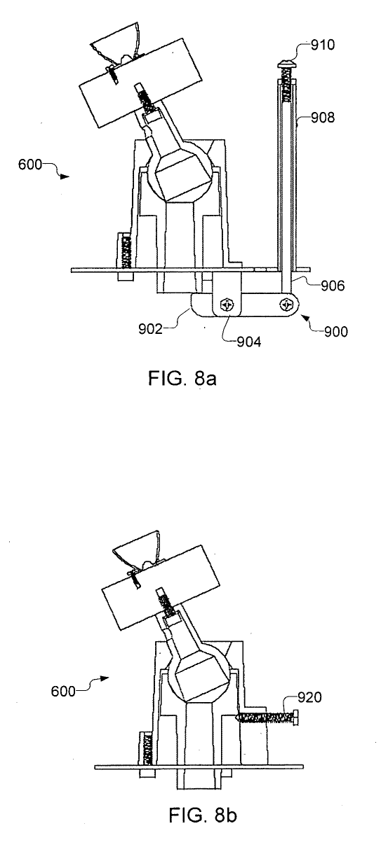

FIG. 8a is a cross-sectional view of an adjustable light source mount assembly including a mechanical linkage in accordance with an exemplary embodiment of the present invention. An adjustable light source mount assembly including a ball and socket may use a mechanical linkage 900 to hold the ball in the socket. The mechanical linkage includes a lever 902 mounted at a pivot point 904 to the light source mount subassembly of the adjustable light source mount subassembly. One end of the lever engages the bottom of the socket plunger of the adjustable light source mount subassembly. The other end of the lever is coupled by a hinge point to a rod 906 extending upwardly through the mounting platform of the adjustable light source mount subassembly. The rod is slidably encased in a tube 908 having an upper opening with an internally threaded portion. The internally threaded portion of the tube receives a threaded member such as a screw. The base of the screw engages the top of the rod.

In operation, the screw is threaded into the internally threaded portion of the tube, pressing the rod downwardly which forces the socket plunger upwardly. The head of the plunger, in turn, forces the ball of the ball and stem assembly against the internal socket of the light source mount subassembly, thereby holding the ball trapped between the internal socket and the socket on the head of the socket plunger. To adjust the aim of the light source assembly, the screw is backed out, which allows the rod to move upwardly, thus releasing the ball from the internal socket. Once the ball is freed, the ball and stem assembly may be adjusted to aim the light source assembly as needed. Once the light source has been aimed, the screw can tightened again, trapping the ball once more.

FIG. 8b is a cross-sectional view of an adjustable light source mount assembly including one or more set screws in accordance with an exemplary embodiment of the present invention. In this embodiment of an adjustable light source mount assembly, a set screw 920 having a tapered tip is threaded into the side of the light source mount subassembly. The tapered tip engages socket plunger just underneath the head. Threading the set screw inwardly forces the head up on the tapered tip of the set screw, which urges the socket plunger upwardly. The head of the plunger, in turn, forces the ball of the ball and stem assembly against the internal socket of the light source mount subassembly, thereby holding the ball trapped between the internal socket and the socket on the head of the socket plunger. To adjust the aim of the light source assembly, the set screw is backed out, which allows the socket plunger to drop slightly, thus releasing the ball from the internal socket. Once the ball is freed, the ball and stem assembly may be adjusted to aim the light source assembly as needed. Once the light source has been aimed, the screw can tightened again, trapping the ball in a fixed location once more.

In another adjustable light source mount assembly in accordance with an exemplary embodiment of the present invention, the mechanical linkage or set screw fixing devices may be used in conjunction with a compression spring extending over the tail of the plunger with the compression spring captured between the head of the plunger and the mounting platform. The compression spring provides a small biasing force to the socket plunger while the ball is freed.

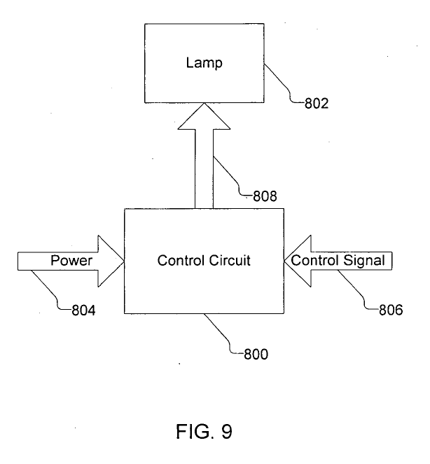

FIG. 9 is a block diagram of a landscape light fixture control system in accordance with an exemplary embodiment of the present invention. As described above, base 206 (of FIG. 2) includes several compartments for electrical junctions and related circuitry. A control circuit 800 may be housed in the base and be coupled to a light source 802. The control circuit may be further coupled to a power source 804 and a control signal 806. The control signal may be used to control how the control circuit delivers power to the light source. For example, the control circuit may be a simple on/off switch that receives an on/off control signal used to turn the light source on and off. As another example, the control signal could encode information in an analog, pulse width modulated or digital format and used to signal the control circuit to apply variable power to the light source, thus working as a dimmer switch. As another example, the light source could be composed of separately energized light source elements, such as different colored light sources or LEDs, and the control signal could encode power levels to be applied to each separate light source element thereby allowing the light source to produce different colored light.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

1. A multi-use landscape light fixture, comprising:
a main housing including an upper flanged opening and a lower flanged opening;
a lens mounting assembly that is sealably and removably attachable to the upper flanged opening;
a light source mounting assembly mounted within an interior portion of the main housing; and
a base comprising:
an upper portion housing a ballast and having a junction box compartment, the upper portion insertable into the lower flanged opening of the main housing; and
a lower flanged bulkhead that removably mates with flanged lower opening of the main housing,
whereby the multi-use landscape light fixture may be mounted above-grade, below-grade or any elevation in between.

2. (canceled)

3. The multi-use landscape light fixture of claim 1, wherein the upper flanged opening of the main housing has a plurality of internally threaded openings for mating with fasteners that secure the lens assembly.

4. The multi-use landscape light fixture of claim 3, wherein an interior of at least one of the internally threaded openings include a channel communicating with an exterior surface of the of the main housing whereby debris may be extruded when a fastener is threaded into the internally threaded openings.

5. The multi-use landscape light fixture of claim 1, wherein the upper portion of the base includes a ballast compartment having an upper opening facing into the interior of the main housing, the upper opening being provided with a cover including a hinged handle on an upper surface of the cover, whereby the handle may be used to retrieve the cover to open the ballast compartment while still stowing away in a compact fashion when not in use.

6. The multi-use landscape light fixture of claim 1, wherein the upper portion of the base includes a ballast compartment having an upper opening facing into the interior of the main housing, the upper opening being provided with a thermally conductive cover to which a ballast is attached.

7. The multi-use landscape light fixture of claim 1, wherein the base includes one or more potted electrical power connectors.

8. The multi-use landscape light fixture of claim 1, wherein the base includes signal connectors.

9. The multi-use landscape light fixture of claim 1, wherein the signal connectors are potted.

10. The multi-use landscape light fixture of claim 1, wherein the lens assembly further comprises a light source mount assembly having an adjustable ball and socket joint.

11. A ballast housing for a light fixture, comprising:
a flanged bulkhead that removably mates with a flanged opening of a light fixture housing; and
a protruding portion having a ballast compartment and a junction box, the protruding portion insertable into the flanged opening of the light fixture housing.

12. The ballast housing for a light fixture of claim 11, wherein ballast compartment includes an opening facing into an interior portion of the light fixture housing, the opening being provided with a cover including a hinged handle on an outer surface of the cover, whereby the handle may be used to retrieve the cover to open the ballast compartment while still stowing away in a compact fashion when not in use.

13. The ballast housing for a light fixture of claim 11, further comprising potted electrical power connectors passing through the bulkhead.

14. The ballast housing for a light fixture of claim 11, further comprising signal connectors passing through the bulkhead.

15. The multi-use landscape light fixture of claim 14, wherein the signal connectors are potted.

16. A light source mount assembly for a light fixture, comprising:
a light source mount subassembly;
a light source subassembly; and
a ball and socket joint coupling the light source mount subassembly and the light source subassembly, the ball held releasably fixed within the socket.

17. The light source mount assembly for a light fixture of claim 16, the ball held in the socket by a resilient member in compression urging the ball into the socket.

18. The light source mount assembly for a light fixture of claim 16, the ball held in the socket by a mechanical linkage.

19. The light source mount assembly for a light fixture of claim 16, the ball held in the socket by one or more set screws.
